(19) United States
(12) Patent Application Publication
(10) Pub. No.: US 2004/0229977 A1
(43) Pub. Date: Nov. 18, 2004

(54) Mold-in color panels

(76) Inventors: Barry Watson, Clarkston, MI (US); Perry J. Palanca, Whitelake, MI (US); Kenneth C. English, Fenton, MI (US); Kris W. Winowiecki, Howell, MI (US)

Correspondence Address: HARNESS, DICKEY & PIERCE, P.L.C., P.O. BOX 828, BLOOMFIELD HILLS, MI, 48303, US

(21) Appl. No.: 10/714,558

(22) Filed: Nov. 13, 2003

Related U.S. Application Data
(63) Continuation-in-part of application No. 10/437,953, filed on May 14, 2003.
(60) Provisional application No. 60/425,978, filed on Nov. 13, 2002.

(51) Int. Cl. C09D 5/29

(52) U.S. Cl. 523/171

(57) ABSTRACT

Low haze or transparent thermoplastic polyolefinic resins have at least one colorant or pigment uniformly distributed therein. The compositions contain a polypropylene material and a second polyolefin comprising copolymer or homopolymer of ethylene or butene. The compositions can be formed into useful mold-in color panel for automotive and other use.

### CROSS-REFERENCE TO RELATED APPLICATIONS

This application claims the benefit of U.S. Provisional Application No. 60/425,978, filed on Nov. 13, 2002, and is a Continuation-in-Part of U.S. Ser. No. 10/437,953, filed May 14, 2003. All of these patents provide useful background for the invention and are incorporated herein by reference.

### FIELD OF THE INVENTION

The present invention relates to thermoplastic compositions and to molded parts made from the compositions.

### BACKGROUND

The automotive industry has worked for decades to increase fuel efficiency of vehicles by replacing a significant amount of steel with lighter parts made out of plastic materials. The industry has moved toward recycling components of vehicles in order to reduce consumption of natural resources.

While the function of modem thermoplastics have been improved, there still is a need to match the quality of a painted surface in terms of depth of color and gloss. Matching a full color palette has been difficult in the past because of the color palette including metallics and special effect pigments. In addition, the vehicle is expected to have the highest quality of depth of color and high gloss. In the past, exterior body panels have either been painted or laminated with a film in order to match the paint chip. However, there are a number of problems relating to these methods of achieving a good color match, including the uneven distribution of the coating film, emissions of VOC during the coating process, cracking of the film at lower temperature, limited flexibility of the film at low temperatures, and excess of film during the laminating process. Added to these are warranty costs involving painting or laminating.

U.S. Pat. No. 6,017,989 to Malm et al describes polypropylene modified by an elastomer (plasticizer) which with pigments are used in automotive molded products. The combination in an unpigmented polymer has a haze level of less than 50% as measured by ASTM D-1003-95. Special effects pigments, whether metallic or pearlescent, are described as being particularly suitable for these polypropylene compositions. The problem is twofold: first, the compositions lose stiffness because of the elastomer and second, the elastomer contributes to a softer surface, which is thus more easily scratchable.

It would be desirable to provide polypropylene compositions that have a very low haze level and have significant strength. It would also be desirable to provide polypropylene compositions that are economical to prepare and are easily injection moldable. It would be further be desirable to provide methods for economically preparing molded articles from the compositions.

### SUMMARY

The present invention relates to thermoplastic compositions and to molded parts—especially automobile body and interior panels—made from the compositions. The compositions contain a first polyolefin comprising a polypropylene material and a second olefin selected from the group consisting of copolymers of ethylene and of one or more C₄₋₁₀ α-olefins, copolymers of 1-butene, and mixtures thereof. The first polyolefin preferably has a haze of less than 20% according to industry standard methods such as ASTM D-1003, as well as a transmittance of greater than 80%. Panels made by molding the compositions exhibit a desirable combination of physical properties. For example the scratch resistance of the panel is characterized in a rating of no more than 2 according to the Ford plastics scratch resistance method FLTM BN 108-13 at seven Newtons force with a one mm ball. The impact resistance of the panel is preferably greater than 2.3 kJ per square meter according to test method ISO 180-93. Preferably the clarity of the panel molded from the compositions without a pigment is greater than 80% according to ASTM D-1003. In preferred embodiments, the compositions further comprise pigments, especially special effects pigments, and the compositions are useful for providing mold-in color panels for automotive and other uses.

The first polyolefin may be a propylene homopolymer, or may be a copolymer of propylene and other olefins such as without limitation ethylene. In preferred embodiments, the polypropylene material is produced by metallocene catalyzed polymerization of propylene. The polypropylene materials are in general crystalline materials, having a crystallinity of 3% or greater.

Exemplary second polyolefins include copolymers of ethylene and butene, copolymers of ethylene and hexene, copolymers of ethylene and octene, homopolymers of 1-butene, and mixtures thereof. In preferred embodiments the second polyolefin has a crystallinity greater than 10% and preferably greater than 20%. In many embodiments, the second polyolefin is produced by metallocene catalyzed polymerization of the respective monomers. The compositions and mold-in color panels also contain pigments selected from the group consisting of color pigments and special effects pigments.

In preferred embodiments, the mold-in color panels produced by molding extruding or otherwise forming the compositions may be used unpainted to provide, for example, a body panel of a car having a pleasing aesthetic appearance. Unpainted polymer panels contains pigment and a non-pigment portion. The non-pigment portion contains greater than 80% by weight of the first polyolefin comprising a polypropylene material with greater than 3% crystallinity and less than 20% by weight of the second polyolefin. The second polyolefin preferably comprises a metallocene catalyzed homo- or copolymer of C₂₋₁₀ α-olefins, wherein the second polyolefin comprises greater than 50 mole percent of C₂₋₄ olefins. The second polyolefin preferably has a crystallinity greater than 3%. The mold-in color panels preferably have scratch resistance, impact resistance, and clarity values such as those discussed above.

The invention also provides methods for making colored polymer articles comprising dispersing a pigment into a polymer composition to form a colored composition, followed by forming the colored composition into the article. In this way, the first polyolefin and second polyolefin are first combined to produce a blend into which the pigment or a concentrate containing the pigment is blended. The composition containing the polymeric components and the pigments may be directly formed into an article such as by molding or extrusion, or may be pelletized for later use. In particularly preferred embodiments, molded panels made from compositions of the invention may be used as a body part for a vehicle which duplicates the color of a painted portion of the vehicle adjacent to the mold-in color panel.

The compositions may contain other optional ingredients, as long as the clarity, physical properties, and aesthetic appearance of the molded parts is not compromised. In some embodiments, the compositions and molded products are essentially free of elastomeric components. In other embodiments, the compositions are essentially free of inorganic fillers, for example, containing less than 5% by weight and preferably less than 1% by weight inorganic fillers. In other embodiments, the compositions further comprise exfoliated inorganic nanocomposites, and optionally a polymeric coupling agent.

Low haze or transparent thermoplastic polyolefinic resins are disclosed that have at least one colorant or pigment uniformly distributed therein. Exemplary embodiments include polymeric compositions that are scratch resistant with fast manufacturing set times. The compositions may be employed in various applications, including automotive applications such as bumper fascia, air dams, other trim, dash boards, air bag covers, and body slide cladding.

### DETAILED DESCRIPTION

Compositions suitable for producing mold-in color panels for automobiles and other uses contain a polymer portion and a non-polymer portion. The non-polymer portion contains pigments as well as optional ingredients such as UV absorbers, slip agents, antioxidants, and others discussed below.

The polymer portion contains two polyolefins. The first polyolefin is a polypropylene material, and the second polyolefin may be a copolymer of ethylene and one or more C₄₋₁₀ α-olefins, or a copolymer of butene. In general, the second polyolefin is a homopolymer or copolymer of C₂₋₁₀ α-olefins, wherein the polyolefin contains at least 50 mole percent of C₂₋₄ olefin. The first polyolefin and second polyolefin are present in the compositions in weight ratios that lead to desired physical properties of panels prepared from the compositions.

In a preferred embodiment, the weight ratio of the first polyolefin to the second polyolefin is at least 2:1, and preferably higher. In some embodiments, the ratio is preferably at least 4:1 and can range up to 10:1 or even 20:1. For example, a composition for producing mold-in color panels comprises a polymer portion containing greater than 40% by weight of a polypropylene material and less than 20% by weight of the second polyolefin. In some embodiments, the polypropylene material makes up 70% by weight or more of the polymer portion, and in other embodiments, greater than 75% by weight of the polymer portion is the polypropylene material. In other embodiments, the polymer portion is made up of 80% by weight or greater of the polypropylene material. In some embodiments, the polymer portion contains greater than 90% by weight of the polypropylene material. The polymer portion of the compositions may contain 20% or less by weight of the second polyolefin. In other embodiments, the second polyolefin makes up less than 15%, preferably less than 10% by weight of the polymer portion of the compositions. In some embodiments, the polymer portion contains less than 5% by weight of the second polyolefin.

Pigmented compositions suitable for making mold-in color panels may be made by dispersing a pigment into a polymer composition to form the pigmented composition. The polymer composition into which the pigment is dispersed contains the first polyolefin and the second polyolefin in weight ratios as discussed above. In general, the polymer composition into which the pigment is dispersed also contains additional optional ingredients such as nucleating agents, antioxidants, slip agents, and the like discussed below.

Mold-in color panels made from the compositions have an advantageous combination of physical properties. For example, the panels have a scratch resistance characterized by a rating of no more than 2 in the Ford plastics scratch resistance test method FLTM BN 108-13 at a 7N force with a 1 millimeter (mm) diameter ball. Further, the impact resistance of the panels is greater than 2.3 kilojoule (kJ) per square meter according to the test method ISO 180-93. Finally, the clarity of the panels measured when made without the pigment is characterized by a transmittance value greater than 80%, and preferably greater than 90%, when measured by ASTM D-1003. The scratch resistance and impact resistance of the panels makes them suitable for use as panels for such applications such as automotive exterior panels, while the clarity of the panel without the pigment leads to panels having an aesthetic appearance when pigment is added. In particular, an advantage offered by the compositions and panels disclosed herein is that they may be formulated with pigments to match the gloss, depth of image, and clarity of painted panels that may be installed adjacent to the mold-in color panels.

Polymer panels made from the compostions may be described as containing a pigment and a non-pigment portion. Typically, such panels are used unpainted as mold-in color panels for automotive and other uses. The non-pigment portion contains the first polyolefin and second polyolefin as well as other optional ingredients, exclusive of the pigment. In particular, the non-pigment portion comprises in preferred embodiments at least 40% by weight of the first polyolefin, preferably greater than 71% by weight, preferably greater than 75% by weight, and in some embodiments greater than 80%, greater than 85%, or greater than 90% by weight of the first polyolefin material. The first polyolefin material is preferably a polypropylene material having a haze of less than 20% and preferably less than 10% percent as measured by ASTM D-1003, and preferably having greater than 3% crystallinity. The non-pigment portion also contains up to 5%, up to 10% by weight, up to 11% by weight, up to 15% by weight, or up to 20% by weight of the second polyolefin. Preferably, the second polyolefin contains at least 50 mole percent of ethylene or butene, and has a crystallinity greater than 3%. In other embodiments, the second polyolefin has a crystallinity greater than 10%, preferably greater than 20%.

Mold-in color panels may also be described in terms of a polymer portion and a non-polymer portion. The polymer portion contains the first polyolefin and the second polyolefin described above. The non-polymer portion contains a pigment and may contain optional ingredients such as antioxidants, UV absorbers, slip agents, nucleating agents, and the like. The pigments used in the panels may be a color pigment or in some embodiments may be a special effects pigment.

In some embodiments, mold-in color panels contain the first polyolefin and second polyolefin, and contain essentially no other polymeric components. Thus in one embodiment, the panel comprises a polymer composition, a pigment selected from the group consisting of color pigments and special effects pigments, and optional additional components such as nucleating agents, slip agents, antioxidant, and UV absorbers. The pigment and the optional components make up the non-polymer portion described above. The polymer composition totals 100 parts and consists of 75 or more parts of a polypropylene material having a haze of less than 20%, preferably less than 10% as measured by ASTM D-1003. The polymer composition also contains 25 parts or less of the second polyolefin, which may be for example a homopolymer of 1-butene, or may be a copolymer of ethylene and one or more C₄₋₁₀ olefins. One preferred second polyolefin is a copolymer of ethylene and octene. Preferably, both the polypropylene material of the first polyolefin and the ethylene copolymer or butene homopolymer of the second polyolefin are produced by metallocene catalyzed polymerization and have a crystallinity greater than 3%.

Compositions disclosed herein may be formulated by a number of methods. In one embodiment, the components of the composition are combined and mixed together to form a blend. The blend may be directly formed into a molded or extruded article, or alternatively may be stored, for example, in the form of pellets, for later use. In some embodiments, the compositions may be directly blended as a pigmented composition, but in other cases it may be preferred to formulate a polymer composition containing the first and second polyolefin, but not containing a pigment. Conveniently, the pigments may be added in a later step, prior to forming, to formulate a pigmented composition for use in forming molded articles.

The polymer composition may contain in addition to the polyolefins, the optional other ingredients described above such as nucleating agents, slip agents, antioxidants, UV absorbers, and the like. In such a situation, the polymer composition may be a precursor composition to forming the compositions suitable for preparing mold-in color panels. Thus, a method is provided for making a colored polymer article such as a mold-in color panel, comprising the steps of dispersing a pigment into a polymer composition to form a colored composition, and forming the colored composition into the article. In this situation, the polymer composition is free of pigment and contains in addition to the first and second polyolefin the optional ingredients discussed above. In some embodiments, the pigment may be provided in the form of a master batch containing the pigments and a polymeric carrier. The polymeric carrier is a polymeric material chosen to be compatible with the other polymeric components of the compositions, that is the first and second polyolefins. A preferred polymeric carrier is a polypropylene material.

After the pigment is dispersed into the polymer composition, the resulting colored composition may be formed into a colored polymer article such as a mold-in color panel by known thermoplastic processing methods, such as injection molding, thermoforming, and compression molding.

The first polyolefin is a high clarity homopolymer or copolymer of propylene. Useful materials include the clarified polypropylenes and clarified random copolymer resins offered by manufacturers such as ExxonMobil. Random copolymer resins typically contain a minor amount of olefin other than propylene, such as 3%, while the clarified polypropylenes can be based on homopolymers of propylene. Preferred polypropylene materials are crystalline in nature, containing a percent crystallinity of 3% or greater. In some embodiments, the crystallinity is considerably higher. For example, suitable materials can have crystallinity greater than 10% or greater than 20%. In other embodiments, the crystallinity of the polypropylene material may be greater than 30%, greater than 50%, or greater than 70%. They are produced by metallocene catalyzed polymerization of propylene, and are characterized by relatively narrow molecular weight distributions. They are further characterized by lower extractable content, lower haze, higher heat deflection temperature, and higher flexural modulus when compared to conventional polypropylenes prepared by Ziegler-Natta catalysis. The materials preferably exhibit a monomodal molecular weight and/or density distribution, and are characterized by a polydispersity (Mw/Mn) of less than 5, preferably less than 3, and typically less than 2. The number average molecular weight can vary, but in some embodiments is above 70,000, and typically about 73,000 or higher. The melt flow rate of the polymers may be used as one estimate of molecular weight. Suitable materials are commercially available, for example from ExxonMobil under the Achieve® tradename.

The second polyolefin is made of copolymers of ethylene and C₄₋₁₀ α-olefins, or may be a homopolymer of butene. Generally, at least 50 mole percent of the polyolefin is ethylene or butene. Non-limiting examples include polybutene, ethylene buten copolymer, ethylene hexene copolymer, and ethylene octene copolymer. Preferred materials are random copolymers of ethylene with one or more other monomers containing 4 or more carbons. The second polyolefin is a crystalline material, typically exhibiting crystallinity above 3%, and in other embodiments, above 10% or above 20%. The melting point of the copolymers is typically above 70° C., and more preferably above 80° C. The second polyolefin may be generally monomodal in molecular weight and/or density distribution. In preferred embodiments, the homopolymers and copolymers of the second polyolefin are produced by metallocene catalysis, and generally have narrower molecular weight distributions than polymers produced by Ziegler-Natta catalysts using aluminum, magnesium, and titanium. Suitable materials are commercially available, for example from ExxonMobil under the Exact® tradename.

The crystallinity of the polymers of the first and second polyolefin may be determined in a number of ways. For example, methods for determining percent crystallinity in polymeric compositions have been developed using nuclear magnetic resonance, x-ray diffraction, and differential scanning calorimetry (DSC). When measured by DSC, the propylene homopolymers produced by metallocene catalysis exhibit a crystallinity above 65%, and preferably above 70%. Achieve® 1635E1 is such a material. On the other hand, metallocene catalyzed propylene homopolymers, such as a propylene-3% ethylene copolymer, typically have a crystallinity below 65%, when measured by DSC.

The compositions and the panels produced from the compositions may contain other polymeric components, as long as the presence of the additional polymeric components does not adversely affect the scratch resistance, impact resistance, and clarity of the molded panels. In a particular embodiment, an elastomer may be used in the compositions in an amount that does not adversely affect the properties. As a general rule, the compositions contain about 3% or less, preferably 2% or less and more preferably 1% or less by weight of elastomeric components. In some embodiments, the compositions contain no elastomers.

As used herein, the term “elastomer” does not include components described above as part of the first or second polyolefin. The term elastomer does include natural and synthetic rubbers such as polymers containing olefinic unsaturation in the polymer backbone. They are normally prepared as homopolymers or copolymers of monomers containing two or more double bonds. Non-limiting examples of such monomers include butadiene and isoprene. Also included in the term “elastomer” are the so-called thermoplastic elastomers. In contrast to natural and synthetic rubbers, which undergo an irreversible cure or crosslinking upon heating, thermoplastic elastomers undergo a reversible change to a phase having elastomeric properties upon cooling. Block polymers such as, without limitation, those of butadiene and styrene are well known thermoplastic elastomers. In many embodiments, elastomers are to be avoided or minimized in compositions disclosed herein, since their use tends to reduce some of the physical properties to unacceptable levels.

In a preferred embodiment of the present invention, colorants, pigments, and dyes are added to the transparent composition of the present invention. As used herein, “colorants” refers to any compound that provides coloring to a composition, including for example, dyes or pigments. “Special effects” pigments include, any colorant including metallic flake pigments, pearlescent pigments, or combinations of metallic flake and pearlescent pigments. Due to the high transparency and/or low haze of the polymer composite blends of the present invention, the pigmented compositions formed from these polymer blends have a depth of color and high gloss that closely matches coatings. In particular, these compositions allow the formulator to produce an appealing aesthetic appearance, including for example, metallic and pearlescent effects necessary to closely match the coatings on automotive bodies when special effects pigments are used, while further providing scratch resistance improving the durability of the finished component.

Pigment is present in amounts that achieve the desired color including hue, intensity, clarity, and opacity. For example, they may be added to compositions of the present invention in amounts of up to about 10% by weight, and preferably between about 4% and about 6% by weight. Preferably, the pigment is pre-mixed with a suitable carrier, such as a low molecular weight polyethylene or polypropylene material, prior to being introduced into compositions of the present invention. Although pigment loading may exceed 10%, the physical properties of polymer blends tend to be adversely affected by such higher pigments loads.

The pigments used may be inorganic or organic. Useful pigments are described for example in U.S. Pat. No. 6,017,989. Special effects pigments including flake alone or in conjunction with color pigments achieve special effects such as a metallic appearances. Inorganic types of pigments include titanium dioxide, carbon black, red iron oxide, black iron oxide, chromium oxide green, and ultramarine blue. Useful organic pigments are metallized and non-metallized azo reds, quinacridone reds, anthraquinone reds, perylene reds, copper phthalocyanine blues and greens, isoindolineone oranges and yellows, carbazole violet, and the like. Inorganic and organic pigments are commercially available from many sources including BASF Corporation in Mt. Olive, N.J.; Cabot Corporation, Billerica, Miss.; Ciba-Geigy Corp., Newport, Del.; and Mineral Pigments Corporation in Beltsville, Md.

The special effect flake pigments and substantially transparent color pigments, if used, may be surface treated, modified, or pre-dispersed separately or together prior to blending with the polymer composition of the present invention.

A preferred method of coloring the polymeric composition is via a color concentrate, where a predetermined amount of pigment or dye is pre-mixed into a predetermined small amount of polymer forming a concentrated color composition, which is later mixed with a polymeric composition to achieve the appropriate color. Other methods of color dispersion may also be used. The amount of pigment and carrier polymer vary according to the pigment used and is readily determined by one skilled in the art to optimize dispersion characteristics or properties of the pigment concentrate. Flake pigments should be processed in a way that avoids bending or breaking the flakes. Other pigments, such as the color pigments mentioned, are preferably pre-dispersed or pretreated. During the pigment dispersion process, pigment agglomerates in the powder pigments are broken down and the pigment may be ground to a predetermined fine size to allow for optimum color development at minimum pigment loadings.

The average particle size of the dispersed pigment, excluding flake pigments, may be less than about one micron, and in some embodiments less than about 0.2 microns. It is generally desirable that the pigment be wet out by the dispersing medium or by the compositions of the present invention in order to attain optimum color development. A prepared pigment paste or concentrate may be introduced into polymer composition during the blending step. The special effects pigments and/or the color pigments, including especially transparent pigments, are preferably uniformly distributed in the polyolefin resin matrix. When the pigments are uniformly distributed, an article containing the pigment, when viewed by the naked eye, appears to have a reasonably uniform color and/or metallic appearance suitable for the intended use of the article.

The compositions and panels of the invention may also contain inorganic fillers such as without limitation talc, calcium silicate, barium sulfate, silica, magnesium alumina silicate, and the like, as long as their use does not adversely affect the desirable properties of the panels. In particular, the use of inorganic fillers should be at a level below that which adversely affects the clarity of the panels or the aesthetic appearance of the pigmented panels. For example, it is preferred to use compositions containing less than 10%, preferably less than 5%, and more preferably less than 1% by weight of talc or other inorganic fillers.

One example of an inorganic filler that may be used at low levels, in compositions of the invention, are the so-called nanocomposites.

One example of a nanocomposite is a surface modified montmorillonite mineral which reinforces the matrix resin composition (e.g. polypropylene) when it is dispersed. Naturally occurring montmorillonite minerals (e.g. clay platelets) derived from smectite silicate clays are typically hydrophilic, nanoscale particles that are agglomerated due to surface attraction. Surface modification reduces attraction at the surface and creates an organophilic structure, capable of absorbing monomers into the space between platelet sheets. This surface modified montmorillonite mineral is thus dispersed throughout the resin matrix, resulting in a nanocomposite. Complete dispersion of the particles is called “exfoliation”. The montmorillonite minerals have very high average aspect ratios (in the range of approximately 200-500), which enables close encounters to be made between the similarly sized resin matrix and the surface modified montmorillonite particles, resulting in a particle-molecule interaction which creates a constrained region at the particle surface, immobilizing a portion of the resin matrix. In some embodiments, such surface modified montmorillonite particles may be used to improve mechanical properties of the matrix. Nanocomposites are compatible with additional fillers or reinforcements in the composite matrix, such as for example, pigments, dyes, and the like. One preferred surface modified montmorillonite mineral available commercially is Nanocor® I-30, a Nanomer®, produced by Nanocor. In some embodiments, the surface modified montmorillonite may be added to the composition of the present invention from about 0.1% to about 5% by weight with most preferable ranges being below 3%. When nanocomposites are present, preferred ranges include for example 0.1 to 2% or preferably 0.5 to 1% by weight.

The compositions may further include a coupling agent, especially when nanocomposites are present. The coupling agent functions to improve the reactivity of a polyolefin resin matrix with reinforcing materials or fillers. The improved adhesion of the polyolefin matrix may provide a composite with improved physical integrity and mechanical properties. Preferably, the coupling agent selection enables reactivity between polypropylene and reinforcing materials (such as the surface modified montmorillonite particles) and/or fillers, such as colorants including inorganic pigments and dyes. Coupling agents also provide compatibility between polyolefins and more polar polymers that interact for alloying, recycling, or co-extrusion processing. One such preferred coupling agent is maleic anhydride functionalized polypropylene, which adds polarity to polypropylene matrices and improves the polypropylene reactivity with inorganic reinforcements at relatively low treat levels. ExxonMobil Chemical manufacturers a maleic anhydride functionalized polypropylene coupling agent, called Exxelor® PO 1020. The coupling agent is added to a preferred embodiment of the present invention in a range of from about 0.5% to about 3% percent by weight. A preferred amount is approximately 1% by weight.

The compositions and panels of the present invention may further contain various other thermoplastics additives, including but not limited to plasticizers, UV absorbers, hindered amine light stabilizers, antioxidants, nucleating agents, slip agents, adhesion promoters and mixtures of these additives. The total amount of additive may be up to 50% by weight of the composition, depending on selection of additives and their respective properties, but is more preferably less than 20%, and usually less than 5%.

The compositions of the present invention can comprise a slip agent. Preferred slip agents are a saturated fatty acid amide or ethylenebis(amide), an unsaturated fatty acid amide or ethylenebis(amide) or combinations thereof. The saturated fatty amides useful in the present invention conform essentially to the empirical formula

RC(O)NHR¹

where R is a saturated alkyl group having of from 10 carbon atoms to 26 carbon atoms and R¹ is independently hydrogen or a saturated alkyl group having of from 10 carbon atoms to 26 carbon atoms. Compounds which conform to the above empirical structure are for example, palmitamide, stearamide, arachidamide, behenamide, stearyl stearamide, palmityl pamitamide, stearyl arachidamide and mixtures thereof.

The saturated ethylenebis(amides) useful in the present invention conform essentially to the empirical formula

RC(O)NHCH₂CH₂ NHC(O)R

where R is as defined previously. Compounds which conform to the above empirical structure are for example, stearamidoethylstearamide, stearamidoethylpalmitamide, palmitamido-ethylstearamide and mixtures thereof.

The unsaturated fatty amides useful in the present invention conform essentially to the empirical formula

R²C(O)NHR³

where R² is an unsaturated alkyl group having of from 10 carbon atoms to 26 carbon atoms and R³ is independently hydrogen or a unsaturated alkyl group having of from 10 carbon atoms to 26 carbon atoms. Compounds which conform to the above empirical structure are for example, oleamide, erucamide, linoleamide, and mixtures thereof.

Unsaturated ethylenebis(amides) useful in the present invention conform essentially to the empirical formula

R⁴C(O)NHCH²CH₂NHC(O)R⁴

where R⁴ is either a saturated or unsaturated alkyl group having of from 10 carbon atoms to 26 carbon atoms with the proviso that at least one of R.sup.4 is unsaturated. Compounds which conform to the above empirical structure include, erucamidoethylerucamide, oleamidoethyloleamide, erucamidoethyloleamide, oleamidoethylerucamide, stearamidoethylerucamide, erucamidoethylpalmitamide, palmitamidoethyloleamide and mixtures thereof.

Generally preferred concentrations of the saturated fatty acid amide or ethylene-bis(amide) are in the range of from about 0 parts to about 0.5 parts by weight, preferably of from about 0.025 parts to about 0.25 parts by weight and most preferably of from about 0.05 parts to about 0.15 parts by weight based on the weight of the total composition. Generally, preferred concentrations of the unsaturated fatty acid amide or ethylene-bis(amide) are in the range of from about 0 parts to about 1 parts by weight, preferably of from about 0.05 parts to about 0.75 parts by weight and most preferably of from about 0.1 parts to about 0.3 parts by weight based on the weight of the total composition.

A preferred embodiment of the composition of the present invention comprises a nucleating agent, which induces crystallization of a polyolefinic polymer, in turn reducing processing cycle times in injection molding and thermoforming. A preferred nucleating agent induces crystallization of polypropylene at high temperatures during processing, while improving the transparency, flexural modulus, and stiffness of the polymeric blend. The nucleating agent is preferably added to the inventive composition from about 0.3% to about 3% by weight. One such nucleating agent is an organophosphate metal salt, such as for example, NA-11 sold by Amfine Chemical Corp. Other examples include, without limitation, aromatic carboxylic acids and their derivatives such as sodium benzoate, aluminum p-tert-butyl benzoate and aluminum benzoate; metal organic phosphates such as sodium di(4-t-butyl phenyl) phosphate and other aromatic phosphates; benzylidine sorbitol derivatives; polyvinyl cycloalkanes such as polyvinyl cyclohexane; and organic dicarboxylic acid derivatives such as sebacic acid. Talc may also be used at low levels as a nucleating agent, as long as its presence does not adversely affect the desired clarity of panels produced from the compositions.

UV light absorbers, light stabilizers, antioxidants, and combinations thereof, are useful for protecting photodegradation sensitive thermoplastics, which degrade to exhibit surface yellowing and erosion which is readily apparent in transparent compositions. Such stabilizers are typically incorporated at low levels, for example from about 0.025% to about 5% by weight of the composition. Examples of UV absorbers include: benzophenones and benzotriazoles, available commercially from a number of sources, including BASF Corp., Cytec Industries, Ciba-Geigy Corp., and Witco Corp. One preferred UV absorber is 2-(2′-Hydroxy-3′,5′-di-t-amylphenyl) benxotriazole sold as the product CYASORB® UV-2337 by Cytec Industries.

As well recognized in the art, light stabilizers (i.e. hindered amine light stabilizers) are typically heterocyclic alcohols (and suitable derivatives thereof) which stabilize plastics. Examples of such preferred compounds include: 1,6-Hexanediamine, N,N′-bis(2,2,6,6-tetramethyl-4-piperidinyl)-,polymers with morpholine-2,4,6-trichloro-1,3,5-triazine (manufactured by Cytec Industries as CYASORB® UV-3529) and hindered amines (e.g. CYASORB® UV-3853 manufactured by Cytec Industries). Particularly preferred compositions of the present invention include both of these light stabilizer compounds. Antioxidants include alkylated phenols and bisphenols, alkylidene polyphenols, and other phenolic derivatives; organic phosphites and phosphates; hydroquinone and its derivatives; and various other compounds known to be useful as antioxidants. A preferred composition of the present invention includes two antioxidants, including 1,3,5-tris (3,5-di-tert-butyl-4-hydroxybenzyl)-s-triazine-2,4,6(1H,3H,5H)trione and Bis(2,4-dicumylphenyl)pentaeythritol diphosphite) commercially available respectively as Cyanox 1741(Cytec Industries) and DoverPhos® S-9228 (Dover Chemical Corporation). As one of skill in the art would recognize, many combinations of light absorbers, light stabilizers, and antioxidants which prevent photodegradation of transparent thermoplastic compositions, such as those formed in the present invention, are both feasible and contemplated.

All of the aforementioned materials may be blended together during a single or multiple blending steps and then the blended composition may be processed into the desired articles. The blending step may be carried out at any convenient temperatures using methods commonly employed in the art. The blending may be done using methods and equipment known in the art, such as for example, a mixer (e.g. a Banbury mixer), a kneader, a monoaxial or biaxial extruder (e.g. single-screw or twin-screw extruders). It is also possible for the blending, in whole or in part, to take place in the equipment used to form the final article, e.g. in the chamber of a single screw injection molding machine.

Various known methods of forming, or processing, thermoplastic materials may be employed to form articles from the compositions of the invention. Examples of suitable processes to process the composition into a component include, without limitation, compression molding, extrusion, thermoforming, and injection molding. A preferred method of processing the compositions of the present invention is injection molding. The present compositions are formulated to have a melt flow appropriate for the molding or forming equipment used. A wide range of melt flow values is possible, for example from about 0.4 to about 35 g/10 min., as measured according the standard ISO 1133.

An alternate embodiment of the present invention includes co-extruding parts, such that an outer layer of the composition of the present invention is combined with an inner, substrate layer from another thermoplastic material. In the case of coextruded parts, the compositions may further include one or more adhesion promoters, or coupling agents. Useful adhesion promoters include acid-modified polyolefinic materials, such as those previously discussed above. In a preferred process, the outer skin formed from the inventive composition is pigmented and laminated onto a body side molding. The lamination process may be accomplished in more than one way. In one preferred embodiment, the outer skin is laminated onto the substrate, particularly onto a body side molding, during the extrusion process by introducing the inventive composition into the extruder and subsequently co-extruding the outer skin and the substrate. In another preferred embodiment, the outer skin and substrate are separately extruded and then the laminate is formed according to the usual methods, for example, by sandwiching an adhesion promoter layer or adhesive between the film and substrate and then applying pressure and heat to bond the layers.

The present invention is adaptable to various applications where thermoplastic composites are suitable. In particularly preferred embodiments, the processes are used to form automotive exterior body parts and molding, examples ranging from seals, trim strips, body side moldings, doors, paneling, fascias, ground effects parts (including spoilers), air dams, door handles, and mirror housings, depending on elastomeric content of the composition. The specific application dictates the desirable elastomer content, with higher elastomeric content well suited for flexible components, such as: window framing, sealing, sill plates, and trim seals, gaskets, and the like. Compositions of the present invention containing minimal amounts of or no elastomers are better suited for exterior body parts, such as side panels, doors, moldings, paneling, and fascias, where more rigidity and strength is preferred. It is especially desirable to form full or partial body panels, doors, and front and rear deck lids from the inventive compositions. Because of the low haze and/or high transparency or clarity of the present polymer compositions, the pigmented compositions offer a scratch resistance high gloss finish with extremely attractive depth of image which may be combined with selected special effect pigments such as aluminum and pearlescent pigments to produce the bright metallic effects and sparkling colors that are widely used in automobile finishes. Such exterior automotive vehicle components formed according to the present invention may be secured to an automobile or vehicle, so that a painted surface is adjacent to the component formed by the present invention. Preferably, the appearance of the component substantially color matches the painted surface of the vehicle. In particular, the exterior automotive vehicle component may be a body side paneling or a bumper fascia.

The present invention is readily adaptable to other applications aside from exterior automotive body parts, and may be used to form other interior automotive parts or articles, such as dash boards, air bag covers, lenses, (including taillight, headlight, and turn signal covers); interior door panels; interior window framing, sealing and trim; seal panels; instrument panel covers; and interior door handles. Non-automotive applications are also contemplated, including lawn and garden equipment, furniture, and items; recreational vehicle interior and exterior parts (e.g. watercraft, snowmobiles, and ATVs); appliance wall panels, both interior and exterior, for appliances including refrigerators and freezers; handles for appliances, equipment, or other articles; trays for refrigerators, freezers, or other articles; and storage boxes or shelves.

The relatively low densities of the nanocomposites compositions of the present invention make them especially desirable for applications in which strength, impact, or other properties must be attained while minimizing weight of the article. Weight of materials has long been a consideration in producing vehicles because added weight reduces fuel mileage. Incorporation of the high aspect ratio fillers (e.g. surface modified montmorillonite minerals) creates a nanocomposite with low density and high strength. The present compositions and materials have the advantage of being stronger, more durable and scratch resistant, with shorter processing times due to quicker set times than various transparent automotive compositions of the past.

With respect to other properties, the present nanocomposite polyolefin compositions can be formulated to achieve flex modulus values in accordance with ISO 178 in the range of from about 300 to about 1300 MPa; impact strenth in accordance with ISO 180/A of 2 KJ/m² to no break at or above 0° C., and between about 1.5 to 40 KJ/m² at −40° C.; and a heat resistance showing no substantial deleterious changes in the material after 25 minutes at 130° C. Scratch resistance testing conducted according to the 5 Finger Scratch Test applies force via a 1 mm pin, and translates scratch resistance by a rating system as follows: a series of different forces are applied to the surface and then evaluated rated in a range of 1 to 5 with relative results ranging from a 1 for no mark to 5 for a deep gouge. The standard incremental forces are applied at 2, 3, 4.5, 6, and 7 N. A formulation according to the present invention was tested accordingly, and found to have a rating of 11222, which is comparable in scratch resistance to an painted component.

The present invention is further illustrated by the following non-limiting examples. All parts are parts by weight unless otherwise noted.

### EXAMPLES

### Example 1

### Preparation of Silver Metallic Material for a Body Side Cladding

The following materials are weighed into a mixer: 92.9 parts Achieve™ 1635E1 (a metallocene-catalyzed polypropylene homopolymer available from ExxonMobil Chemical); 4.5 parts Exact 0201 (an ethylene octene copolymer impact modifier available from ExxonMobil Chemical); 1 part Exelor PO 1020 (a coupling agent available from ExxonMobil Chemical); 0.5 parts Nanocor 130 (a surface modified montmorillonite mineral filler available from Nanocor®); 0.4 parts Amfine NA-11 (a stabilizing nucleating agent available from Amfine Chemical Corp.); 0.2 parts Cyasorb® UV-2337 (UV light absorber available from Cytec Industries); 0.2 parts Cyasorb® UV-3529 (light stabilizer available from Cytec Industries); 0.2 parts Cyasorb® UV-3853 (light stabilizer available from Cytec Industries); 0.05 parts Cyanox 1741 (antioxidant available from Cytec Industries); and 0.05 parts DoverPhos® S-9228 (antioxidant available from Dover Chemical Corp.). The ingredients are mixed for about one minute at high shear to form a matrix.

When the drop temperature of the batch reaches about 340° F., the batch is dropped into a single-screw extruder. Aluminum flake pigment (available commercially from Silberline) and white mica flake (available from EM Industries) is metered into the front end of the extruder in a ratio of 2 parts aluminum and 2 parts of mica per 100 parts of matrix. In certain applications, these components are introduced in a concentrate. The mixture is extruded and then pelletized underwater using an underwater pelletizer. The pellets are suitable for extrusion or the conventional forming process using heat into automotive vehicle components or other articles, as known to one of skill in the art.

The description of the invention is merely exemplary in nature and, thus, variations that do not depart from the gist of the invention are intended to be within the scope of the invention. Such variations are not to be regarded as a departure from the spirit and scope of the invention.

### Examples 2-9

The following components are used in Examples 2-9:

Achieve 1635 is a metallocene polypropylene from ExxonMobil.

Exact 0201 is a metallocene catalyzed copolymer of ethylene and octene, from ExxonMobil.

Amfine NA-11 is a nucleating agent.

Cyasorb UV-2337 is 2-(2′-hydroxy-3′,5′-di-t-amylphenyl)benzotriazole, from Cytec Industries.

Cyasorb UV-3529 is a polymeric hindered amine light stabilizer (HALS) from Cytec.

Cyasorb UV-3853s is a HALS 50% in a low density polyethylene resin, from Cytec.

Cyasorb UV-3853 pp5 is a HALS 50% in a polypropylene resin, from Cytec.

Dovernox 811 is an antioxidant for polypropylene, produced by Dover Chemical Corporation.

Cyasorb THT-7001 is a light stabilizer for polyolefins, sold by Cytec.

Atmer SA-1759 FD is an oleamide slip agent with a melting point of 70-76° C., sold by Ciba Specialty Chemicals.

Ciba EB 40-70 FF is a uv absorber from Ciba Specialty Chemicals.

Tinuvin 328 is a hydroxyphenyl benzotriazole sold by Ciba.

Tinuvin 120 is a uv absorber from Ciba.

Irgafos 168 is tris(2,4-di-tert-butylphenyl)phosphite, an antioxidant.

Irganox 1076 is octadecyl 3,5-di-(tert)-butyl-4-hydroxyhydrocinnamate, an antioxidant.

Examples 2-9 give formulations of polymer compositions used in making mold in panels of the invention. Amounts of the components are given in weight fraction rather than percent. The components of the Examples are blended and pelletized. To make mold-in color panels, a pigment, preferably in the form of a masterbatch is dispersed into the polymer composition. The composition is then molded into a panel.

Pigment concentrates may be hand blended into the polymer compositions at a weight ration of 25 parts polymer composition to 1 part pigment concentrate. Automated procedures may also be used. Higher or lower levels of pigment concentrate may be used depending on the desired level and color. The dry blending is carried out until the pigment is uniformly dispersed into the polymer composition. Uniform mixing is important to achieve consistent pigment concentration throughout the molded part. The uniformly mixed colored composition should be used with a properly designed injection molding machine to provide the proper amount of shear to give a uniform mix of pigment within the polyolefin matrix.

Panels made from the compositions of Examples 2-9 exhibited a scratch resistance having a rating of no more than 2 with a 7N force on a 1 mm diameter measured according to test method FLTM BN 108-13, and an impact resistance of greater than 2.3 kJ/m² as measured by ISO 180-93. The transmittance of the panels formulated without the pigment was more than 80%, as measured by ASTM D-1003.

| | Example | | Example | | Example | | Example | | Example | | Example | | Example | | Example | |
|---|---|---|---|---|---|---|---|---|---|---|---|---|---|---|---|---|
| | 2 | | 3 | | 4 | | 5 | | 6 | | 7 | | 8 | | 9 | |
| | Wt | | Wt | | Wt | | Wt | | Wt | | Wt | | Wt | | Wt | |
| Material | Fraction | Lbs | Fraction | Lbs | Fraction | Lbs | Fraction | Lbs | Fraction | Lbs | Fraction | Lbs | Fraction | Lbs | Fraction | Lbs |
| Achieve | 0.944 | 472 | 0.908 | 45.4 | 0.908 | 45.4 | 0.911 | 45.55 | 0.91 | 45.5 | 0.911 | 45.55 | 0.91 | 45.5 | 0.853 | 42.65 |
| 1635 | | | | | | | | | | | | | | | | |
| Exact | 0.045 | 22.5 | 0.045 | 2.25 | 0.045 | 2.25 | 0.045 | 2.25 | 0.045 | 2.25 | 0.045 | 2.25 | 0.45 | 2.25 | 0.1 | 5 |
| 0201 | | | | | | | | | | | | | | | | |
| Amfine | 0.002 | 1 | 0.004 | 0.2 | 0.004 | 0.2 | 0.004 | 0.2 | 0.004 | 0.0 | 0.004 | 0.2 | 0.004 | 0.2 | 0.004 | 0.2 |
| NA-11 | | | | | | | | | | | | | | | | |
| Cyasorb | 0.002 | 1 | 0.002 | 0.1 | 0.002 | 0.1 | 0 | 0 | 0 | 0 | 0 | 0 | 0 | 0 | 0.002 | 0.1 |
| UV-2337 | | | | | | | | | | | | | | | | |
| Cyasorb | 0.002 | 1 | 0.002 | 0.1 | 0.002 | 0.1 | 0 | 0 | 0 | 0 | 0 | 0 | 0 | 0 | 0.002 | 0.1 |
| UV-3529 | | | | | | | | | | | | | | | | |
| Cyasorb | 0.004 | 2 | 0.008 | 0.4 | 0.008 | 0.4 | 0 | 0 | 0 | 0 | 0 | 0 | 0 | 0 | 0 | 0 |
| UV-3853s | | | | | | | | | | | | | | | | |
| Cyasorb | 0 | 0 | 0 | 0 | 0 | 0 | 0 | 0 | 0.008 | 0.4 | 0 | 0 | 0.008 | 0.4 | 0.008 | 0.4 |
| UV- | | | | | | | | | | | | | | | | |
| 3853PPS | | | | | | | | | | | | | | | | |
| Dovernox | 0.001 | 0.5 | 0.001 | 0.05 | 0.001 | 0.05 | 0 | 0 | 0.001 | 0.05 | 0 | 0 | 0.001 | 0.05 | 0.001 | 0.05 |
| 811 | | | | | | | | | | | | | | | | |
| Cyasorb | 0 | 0 | 0 | 0 | 0 | 0 | 0 | 0 | 0.002 | 0.1 | 0 | 0 | 0.002 | 0.1 | 0 | 0 |
| THT-7001 | | | | | | | | | | | | | | | | |
| Atmer | 0 | 0 | 0.03 | 1.5 | 0 | 0.05 | 0.03 | 1.5 | 0.03 | 1.5 | 0 | 0 | 0 | 0 | 0.03 | 1.5 |
| SA-1759 | | | | | | | | | | | | | | | | |
| FD | | | | | | | | | | | | | | | | |
| Ciba | 0 | 0 | 0 | 0 | 0 | 0 | 0.004 | 0.2 | 0 | 0 | 0.004 | 0.2 | 0 | 0 | 0 | 0 |
| EB 40-70 | | | | | | | | | | | | | | | | |
| FF | | | | | | | | | | | | | | | | |
| Tinuvin | 0 | 0 | 0 | 0 | 0 | 0 | 0.002 | 0.1 | 0 | 0 | 0.002 | 0.1 | 0 | 0 | 0 | 0 |
| 328 | | | | | | | | | | | | | | | | |
| Tinuvin | 0 | 0 | 0 | 0 | 0 | 0 | 0.002 | 0.1 | 0 | 0 | 0.002 | 0.1 | 0 | 0 | 0 | 0 |
| 120 | | | | | | | | | | | | | | | | |
| Irgafos | 0 | 0 | 0 | 0 | 0 | 0 | 0.001 | 0.05 | 0 | 0 | 0.001 | 0.05 | 0 | 0 | 0 | 0 |
| 168 | | | | | | | | | | | | | | | | |
| Irganox | 0 | 0 | 0 | 0 | 0 | 0 | 0.001 | 0.05 | 0 | 0 | 0.001 | 0.05 | 0 | 0 | 0 | 0 |
| 1076 | | | | | | | | | | | | | | | | |
| Ciba | 0 | 0 | 0 | 0 | 0.03 | 1.5 | 0 | 0 | 0 | 0 | 0.03 | 1.5 | 0.03 | 1.5 | 0 | 0 |
| CGX SM | | | | | | | | | | | | | | | | |
| 730 | | | | | | | | | | | | | | | | |
| Total | 1 | 500 | 1 | 50 | 1 | 50 | 1 | 50 | 1 | 50 | 1 | 50 | 1 | 50 | 1 | 50 |

We claim:

1. A mold-in color panel comprising a polymer portion and a non-polymer portion, wherein the polymer portion comprises
a first polyolefin comprising a polypropylene material having a haze of less than 20% and a transmittance greater than 80%; and
a second polyolefin selected from the group consisting of a copolymer of ethylene and one or more C₄₋₁₀ α-olefins, a hompolymer of 1-butene, and mixtures thereof; and
the non-polymer portion comprises a pigment,
wherein the scratch resistance of the panel is sufficient to give a rating of no more than 2 at 7N force with a 1 mm diameter ball when measured according to test method FLTM BN 108-13, the impact resistance of the panel is greater than 2.3 kJ/m² as measured by ISO 180-93, and the transmittance of the panel measured without the pigment is greater than 80%, wherein the haze and transmittance are measured according to ASTM D1003.

2. A panel according to claim 1, wherein the non-polymeric portion further comprises antioxidants or UV absorbers.

3. A panel according to claim 1, wherein the non-polymer portion further comprises slip agents.

4. A panel according to claim 1, wherein the non-polymer portion further comprises polypropylene nucleating agents.

5. A panel according to claim 1, wherein the second polyolefin comprises the product of a metallocene catalyzed polymerization.

6. A panel according to claim 5, wherein the second polyolefin is selected from the group consisting of copolymers of ethylene and butylene, copolymers of ethylene and hexene, and copolymers of ethylene and octene.

7. A panel according to claim 5, wherein the second polyolefin comprises a copolymer of ethylene and octene.

8. A bumper according to claim 1.

9. An interior panel according to claim 1.

10. A panel according to claim 1, wherein the pigment is a special effects pigment.

11. A panel according to claim 1, wherein the pigment is a color pigment.

12. A panel according to claim 1, wherein the first polyolefin comprises a homopolymer of propylene.

13. A panel according to claim 1, wherein the polymer portion consists of the first polyolefin and the second polyolefin.

14. A panel according to claim 1, wherein the weight ratio of the first polyolefin to the second polyolefin is at least 2:1.

15. A composition suitable for producing mold in color panels for automobiles and other uses comprising a polymer portion and a non-polymer portion, wherein the polymer portion comprises:
greater than 40% by weight of a polypropylene material having greater than 3% crystallinity and exhibiting a haze less than 20% or a transmittance greater than 80%; and
less than 20% by weight of a substantially linear copolymer of ethylene and one or more C₄₋₁₀ α-olefins, wherein the copolymer has greater than 3% crystallinity and is produced by polymerization with a metallocene catalyst; and
wherein the non-polymer portion comprises a pigment selected from the group consisting of a color pigment and a special effects pigment.

16. A composition according to claim 15, wherein the polymer portion comprises greater than 70% by weight of the polypropylene material.

17. A composition according to claim 15, wherein the polymer portion comprises greater than 75% by weight of the polypropylene material.

18. A composition according to claim 15, wherein the polypropylene material is produced by metallocene catalysis.

19. A composition according to claim 15, wherein the composition is free of ethylene polypropylene block copolymer.

20. A composition according to claim 15, wherein the composition is free of elastomers.

21. A composition according to claim 15, wherein the polymer portion comprises less than 15% by weight of the copolymer.

22. A composition according to claim 15, wherein the copolymer comprises a copolymer of ethylene and octene.

23. A composition according to claim 15, wherein the copolymer has a melting point greater than 70° C.

24. A composition according to claim 15, wherein the copolymer has a melting point greater than 80° C.

25. A composition according to claim 15, wherein the copolymer has greater than 20% crystallinity.

26. A composition according to claim 15, comprising essentially no inorganic filler.

27. A mold in color panel, having scratch resistance giving a rating of no more than 2 at 7N force with a 1 mm diameter ball by test method FLTM BN 108-13 and impact resistance greater than 2.3 kJ/m² according to ISO 180-93, the panel comprising:
greater than 75% by weight crystalline polypropylene produced by metallocene catalyzed polymerization of propylene, and having a transmittance of 80% or greater or a haze less than 20%;
less than 15% by weight of a metallocene produced copolymer of ethylene and one or more C₄₋₁₀ α-olefins, the copolymer having a crystallinity greater than 20% by weight and a melting point greater than 80° C.; and
a pigment selected from the group consisting of color pigments and special effects pigments,
wherein the haze of the panel without the pigment is 20% or less, with haze and transmittance determined according to ASTM D1003.

28. A panel according to claim 27, further comprising a nucleating agent for the polypropylene.

29. A panel according to claim 27, further comprising a slip agent comprising a fatty acid amide.

30. A panel according to claim 27, wherein the copolymer comprises an ethylene-octene copolymer.

31. A panel according to claim 27, wherein the copolymer comprises an ethylene-butene copolymer.

32. A panel according to claim 27, comprising less than 11% by weight ethylene-hexene copolymer.

33. A panel according to claim 27, comprising less than 11% by weight ethylene-octene copolymer.

34. A panel according to claim 27, essentially free of inorganic filler.

35. A panel according to claim 27, further comprising a nanocomposite filler.

36. A mold-in color panel, comprising
a polymer composition totaling 100 parts and consisting of 75 or more parts of a polypropylene material having a haze less than 20% and 25 parts or less of a copolymer and ethylene and octene, wherein the polypropylene and the copolymer are produced by metallocene catalyzed polymerization and have greater than 3% crystallinity,
a pigment selected from the group consisting of color pigments and special effects pigments; and
optional additional components selected from the group of nucleating agents, slip agents, antioxidants, and UV absorbers,
wherein the panel has scratch resistance to give a rating of no more than 2 according to FLTM BN 108-13 at 7N Force with a 1 mm diameter ball, impact resistance greater than 2.3 kJ/m according to ISO 180-93, and wherein the panel without the pigment has a haze less than 20% measured according to ASTM D1003.

37. A panel according to claim 36, wherein the polymer composition has 80 or more parts polypropylene and 20 or less parts of the copolymer.

38. A panel according to claim 36, wherein the polymer composition has 85 or more parts polypropylene and 15 or less parts of the copolymer.

39. An unpainted polymer panel comprising a pigment and a non-pigment portion, wherein the non-pigment portion comprises
more than 80% by weight of a polypropylene material with greater than 3% crystallinity; and
less than 20% by weight of a polyolefin other than the polypropylene, comprising a metallocene catalyzed homo- or copolymer of C₂₋₁₀ olefins, the polyolefin comprising at least 50 mole % of C₂₋₄ olefins and having a crystallinity greater than 3%;
wherein the panel has scratch resistance to give a rating of no more than 2 according to FLTM BN 108-13 at 7N Force with a 1 mm diameter ball, impact resistance greater than 2.3 kJ/m² according to ISO 180-93, and wherein the panel without the pigment has a haze less than 20% measured according to ASTM D1003.

40. A panel according to claim 39, wherein the polyolefin has a crystallinity greater than 10%.

41. A panel according to claim 39, wherein the polyolefin has a crystallinity greater than 20%.

42. A panel according to claim 39, wherein the polypropylene material is a product of metallocene catalyzed polymerization of propylene.

43. A panel according to claim 39, wherein the polypropylene material comprises a homopolymer of propylene.

44. A panel according to claim 39, wherein the polypropylene material is a propylene homopolymer.

45. A panel according to claim 39, wherein the panel comprises essentially no elastomers.

46. A panel according to claim 39, wherein the polyolefin comprises a copolymer of ethylene and octene.

47. A panel according to claim 39, wherein the polyolefin comprises a homopolymer of 1-butene.

48. A panel according to claim 39, wherein the polyolefin comprises a copolymer of ethylene and butene.

49. A panel according to claim 39, wherein the polyolefin comprises a copolymer of ethylene and hexene.

50. A panel according to claim 39, wherein the non-pigment portion further comprises a nanocomposite filler.

51. A method for making a colored polymer article, comprising
dispersing a pigment into a polymer composition to form a colored composition, and
forming the colored composition into the article,
wherein the polymer composition comprises
greater than 40% by weight of a polypropylene material having greater than 3% crystallinity and exhibiting a haze less than 20% or a transmittance greater than 80%; and
less than 20% by weight of a substantially linear copolymer of ethylene and one or more C₄₋₁₀ α-olefins, wherein the copolymer has greater than 3% crystallinity and is produced by polymerization with a metallocene catalyst.

52. A method according to claim 51, wherein the pigment is provided in the form of a masterbatch comprising pigment and a polymeric carrier.

53. A method according to claim 52, wherein the polymeric carrier comprises a polypropylene material.

54. A method according to claim 51, wherein forming comprises injection molding.

55. A method according to claim 51, wherein forming comprises thermoforming

56. A method according to claim 51, wherein forming comprises compression molding.

57. A method for making a colored polymer article, comprising
dispersing a pigment into a polymer composition to form a colored composition, and
forming the colored composition into the article,
wherein the polymer composition comprises
more than 80% by weight of a polypropylene material with greater than 3% crystallinity; and
less than 20% by weight of a polyolefin other than the polypropylene, comprising a metallocene catalyzed homo- or copolymer of C₂₋₁₀ olefins, the polyolefin comprising at least 50 mole % of C₂₋₄ olefins and having a crystallinity greater than 3%.
